(19) United States
(12) Patent Application Publication
(10) Pub. No.: US 2013/0226047 A1
(43) Pub. Date: Aug. 29, 2013

(54) KNEE MOBILITY THERAPY APPARATUS

(71) Applicant: Zaitun BEGAM, Leesburg, VA (US)

(72) Inventor: Zaitun BEGAM, Leesburg, VA (US)

(21) Appl. No.: 13/403,213

(22) Filed: Feb. 23, 2012

(51) Int. Cl. A61H 1/02

(52) U.S. Cl. 601/34

(57) ABSTRACT

A knee mobility therapy apparatus is described. The apparatus is designed for use by a patient in a seated position having the foot of the leg to be treated resting on the top flat surface of the device. The device is designed to only go forward and backwards so as not to put strain on the knee of the patient. The device is oriented by the patient so the leg may only go forwards and backwards.

### BACKGROUND OF THE INVENTION

1. Field of the Invention

The present invention relates to the field of medical devices. More specifically, the invention relates to a device for physical therapy of the knee, which can be used by a patient while recovering from a knee injury or knee surgery, and which can be used without doctor supervision.

2. Description of Related Art

It is important that patients recovering from a knee injury or knee surgery initiate knee flexion and straightening therapy promptly after the injury or surgery to maintain knee joint flexibility and shorten the period for recovery. Patient compliance with a predetermined physical therapeutic protocol is key to early patient recovery with optimal joint flexibility and function. While there have been many devices developed to provide knee flexion/extension and exercise therapy, each has its complexities or difficulties of use that have tended to reduce patient compliance with therapeutic protocols designed for early and effective recovery.

### SUMMARY OF THE INVENTION

The present invention provides a knee mobility therapy apparatus that can be easily transported for patient home use, and one that can be used by the postoperative or post-trauma patient with minimal instruction and without assistance of attending medical practitioners, family members, or friends. The present invention provides a simple, effective, knee mobility therapy device. The device allows the patient to sit in a comfortable position during each therapy session. That, coupled with its simple confined motion design, allows for efficient and effective delivery of flexion/extension movements and constitutes a significant improvement over knee extension therapeutic devices that previously have been available.

In general, the device comprises a platform or base having a core with an upper surface upon which a subject's foot rests, and a lower surface to which a rolling means is attached. The rolling means can be any suitable structure that allows the device as a whole to move with relation to the ground (e.g., a smooth floor), the only limitation being that movement is restricted to two directions (i.e., forward and backward).

The invention further provides a method for therapeutic knee flexion and extension. The method generally comprises use of the therapeutic device of the present invention. More specifically, the therapeutic method comprises placing the foot of a subject on the upper surface of the device of the invention, and moving the device forward and backward along the ground through flexion and extension of the patient's knee. The movement of the device is limited to forward and backward, which minimizes stretching or twisting of the knee in directions other than forward and backward, and thus minimizes additional damage to the knee during the recovery period.

### BRIEF DESCRIPTION OF THE DRAWINGS

FIG. 1 is a perspective view of the apparatus in accordance with the present invention.

FIG. 2 is a plain view of the apparatus in FIG. 1 showing the top surface of the base to be used for placing the patients foot upon.

### DETAILED DESCRIPTION OF PREFERRED EMBODIMENTS

The device of the invention comprises a base or platform. The base can be any size and shape that can stably support a human foot of a person in a sitting position. While the size and shape is not limited, in general the base will be generally rectangular, with a width of about 10 cm to about 25.4 cm (about 4-10 inches) and a length of about 20 cm to about 92 cm (about 8-16 inches). However, it is to be understood that any size and shape can be used, including, but not limited to square, triangle, round, or a complex shape, such as the shape of a human foot.

The base comprises a solid material that is sufficient strong to support a foot of a person in a sitting position. The solid material is not particularly limited, and can be, for example, a piece of wood, plastic, metal, or similar material, or a combination thereof.

The base comprises a top or upper surface and a lower surface. The upper surface can be of the same material as the core of the base, or can be made of a different material. In one exemplary embodiment of the invention, the base is designed with a no slip top surface so the patient's foot does not slip off. For example, the top surface of the base can include a non-slip mat of rubber, plastic vinyl, carpet, or other non-slip covering. In some embodiments where the top surface includes a material that is different than the core of the base, the top surface is easily removable, for example for replacement or cleaning.

The lower surface of the base is not particularly limited in composition, and is typically made of the same material as the core of the base. The lower surface serves as a connection point for the rolling means. The rolling means is attached to the lower surface by way of any common fastener, such as, but not limited to, screws, nails, staples, and adhesive.

The rolling means is any structure that is suitable for allowing the device as a whole to move with relation to the ground, but only in two directions (i.e., forward and backward). The rolling means can be any of the various known objects that are suitable for attaching to other objects to enable the objects to roll. Non-limiting examples of rolling means include wheels, rollers, casters, bearings, and the like. The device of the invention includes at least one rolling means, which can be a single individual rolling object or a combination of two or more rolling objects together in a single housing to form a unit. For example, a rolling means can be configured as a unit of two or more wheels in the fashion of an in-line skate. Alternatively, a rolling means can be configured as multiple wheels in a side-by-side alignment across the width of the platform. Regardless of the configuration chosen, it is preferred that the rolling means are configured in a way that limits side-to-side rocking of the platform, so as to limit stretching and twisting of the knee of the patient.

In exemplary embodiments, the base is attached with two or more wheels mounted on the bottom surface. The wheels are fixed in their orientation such that only front/back motion is possible for the base.

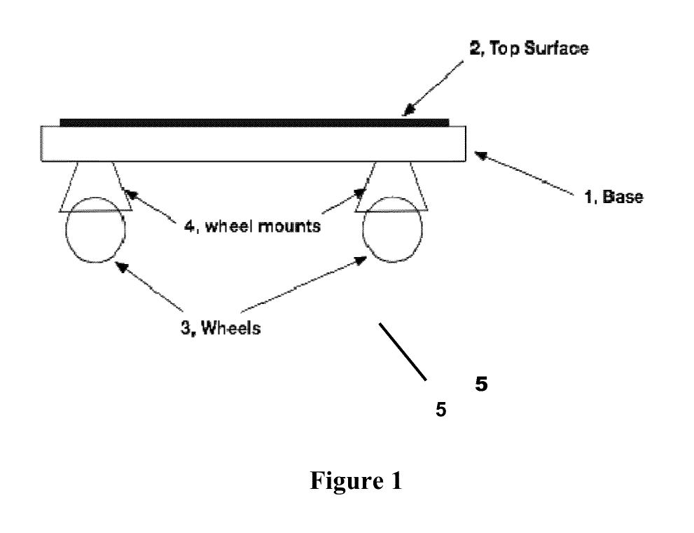

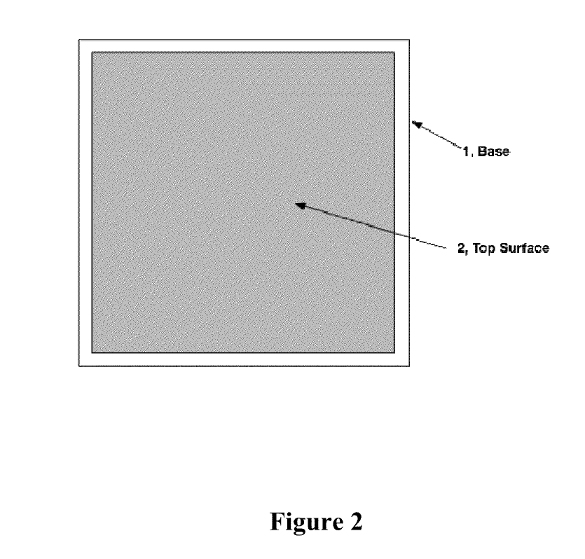

Turning now to the figures, with reference to FIGS. 1-2, there is in accordance with this invention a knee mobility therapy apparatus 5 for use by a patient (not shown) sitting with his foot (not shown) placed upon the top surface 2 of the device. The apparatus includes a base 1 that is made to only move in the forward/backwards direction by way of locking or otherwise adjusting the wheels 3 such a way as to limit the degrees of motion to only two directions—forward and backward, so as to not damage the knee joint of the patient while the device is in use.

The base may include a built in non-slip surface, such as built in groves or bumps, so that the patient's foot may stay securely on the platform. For example, the base may include a foot mount for the patient to firmly attach the patient's foot to the base. Any of a number of foot mount designs can be used, including, but not limited to, a strap.

The present invention has been described with reference to the appended drawings and such description is for illustrative purposes only. The invention is not intended to be limited by the preferred embodiments illustrated in the drawings. Those skilled in the art will appreciate that the scope of the invention extends to other comparable embodiments.

1. A knee mobility therapy device for use by a patient in a seated position, said device comprising:
a base or platform having a core, an upper surface onto which a foot can be placed, and a lower surface for attachment of rolling means; and
rolling means,
wherein the rolling means are configured to allow the device to roll in a forward and backward direction only.

2. The device of claim 1, wherein the upper surface comprises a non-slip material that is different in composition from the core of the base.

3. The device of claim 1, wherein the rolling means comprises one or more wheels, rollers, or casters.

4. The device of claim 1, wherein the rolling means functions as a guiding system, which is designed to only travel in a forward/backwards direction.

5. The device of claim 1, wherein the base may built with a non-slip surface for the patients foot.

6. A therapeutic method for rehabilitating a knee that has been injured or subject to surgery, said method comprising:
placing the foot of a patient on the upper surface of the device of claim 1, and
moving the device forward and backward along the ground through flexion and extension of the patient's knee,
wherein movement in a forward and backward direction assists in rehabilitation of the patient's knee.

7. The method of claim 6, wherein movement of the device is limited to forward and backward, which minimizes stretching or twisting of the knee in directions other than forward and backward, and thus minimizes additional damage to the knee during a recovery period.

8. The method of claim 6, which is a method for therapeutic knee flexion and extension.
